(19) United States
(12) Patent Application Publication
(10) Pub. No.: US 2014/0310070 A1
(43) Pub. Date: Oct. 16, 2014

(54) COORDINATED BUSINESS RULES MANAGEMENT AND MIXED INTEGER PROGRAMMING

(71) Applicant: International Business Machines Corporation, Armonk, NY (US)

(72) Inventors: Vincent Beraudier, Valbonne (FR); Philippe Couronne, Valbonne (FR); Georges-Henri Moll, Villeneuve-Loubet (FR)

(73) Assignee: International Business Machines Corporation, Armonk, NY (US)

(21) Appl. No.: 14/227,794

(22) Filed: Mar. 27, 2014

Related U.S. Application Data
(63) Continuation of application No. 13/861,483, filed on Apr. 12, 2013.

(51) Int. Cl. G06Q 10/06

(52) U.S. Cl. CPC G06Q 10/0637
USPC 705/7.36

(57) ABSTRACT

Embodiments of the present invention provide a method, system and computer program product for an integrated business rules management system (BRMS) and mixed integer programming (MIP) technology application deployment. In an embodiment of the invention, a method of rules processing with MIP constraints can include selecting candidate rules from amongst a set of rules in a rules engine executing in memory of a computer and reducing the candidate rules to rules in a conflict set according to constraints specified in the candidate rules. The method also can include conflict resolving the rules in the conflict set and generating an agenda for the rules of the conflict set. Finally, the method can include adding constraints specified in the rules of the conflict set to working memory of the rules engine and applying the rules in the conflict set in agenda order to the working memory.

### CROSS-REFERENCE TO RELATED APPLICATIONS

This application is a Continuation of U.S. application Ser. No. 13/861,483, filed Apr. 12, 2013, currently pending, the entirety of which is incorporated herein by reference.

### BACKGROUND OF THE INVENTION

1. Field of the Invention

The present invention relates to business rules management and more particularly to integrated business rules and constraints.

2. Description of the Related Art

A business rule management system (BRMS) is a software system used to define, deploy, execute, monitor and maintain the variety and complexity of decision logic that is used by operational systems within an organization or enterprise. The decision logic, namely “business rules”, includes policies, requirements, and conditional statements that are used to determine the tactical actions that take place in applications and systems. At the minimum, a BRMS includes a repository, allowing decision logic to be externalized from core application code, tools that allow both technical developers and business experts to define and manage decision logic, and a runtime environment in which applications can invoke decision logic managed within the BRMS and execute the decision logic using a business rules engine.

In a typical BRMS, one or more rules in a rule set are selected according to matching criteria (or exclusionary criteria) for an input. The selected rules are then applied once to the input and this process is repeated for all inputs offered to the system. Thus, to the extent rules can be modified by the end user, the use of a BRMS has been found to reduce or remove reliance on information technology (IT) departments for changes in live systems. The use of a BRMS also has been found to provide increased control over implemented decision logic for compliance and better business management, and also the ability to express decision logic with increased precision, using a business vocabulary syntax and graphical rule representations such as decision tables, trees, scorecards and flows. Finally, the use of a BRMS has been found to improve efficiency of processes through increased decision automation.

Presently, BRMS and mixed integer programming (MIP) technologies remain separate from one another. Rules technology addresses controlling a system, such as business process model monitoring and piloting, online products ordering, and production execution. Therefore, BRMS technology addresses short term decision making by allowing the construction of fast, reactive applications. By comparison, MIP technology is an optimization technology aimed at finding the best solution to large scale problems in which data is precisely known, sufficiently in advance. Consequently, MIP technology addresses long to mid-term decision making, like production planning and scheduling, crew scheduling and the like.

Very often, the choice of whether to employ BRMS technology or MIP technology to solve a business problem is not obvious. In particular, some applications require both fast reactivity, with rules that should be dynamically changeable without re-deployment, and also the maintenance of an optimal (or sometimes just a feasible) solution with regard to linear constraints—namely decision variables, integer or continuous, that are subject to weighted sums of their values being constrained to be equal, superior or inferior to a constant.

### BRIEF SUMMARY OF THE INVENTION

Embodiments of the present invention address deficiencies of the art in respect to BRMS technology deployment and provide a novel and non-obvious method, system and computer program product for an integrated BRMS and MIP technology application deployment. In an embodiment of the invention, a method of rules processing with MIP constraints can include selecting candidate rules from amongst a set of rules in a rules engine executing in memory of a computer and reducing the candidate rules to rules in a conflict set according to constraints specified in the candidate rules. The method also can include conflict resolving the rules in the conflict set and generating an agenda for the rules of the conflict set. Finally, the method can include adding constraints specified in the rules of the conflict set to working memory of the rules engine and applying the rules in the conflict set in agenda order to the working memory.

In another embodiment of the invention, a rules processing data processing system is provided. The system includes a computer with at least one processor and memory, a rules engine executing in the computer; and a MIP optimization engine coupled to the rules engine. The rules engine can be configured to select candidate rules from amongst a set of rules, reduce the candidate rules to rules in a conflict set according to constraints specified in the candidate rules, conflict resolve the rules in the conflict set, generate an agenda for the rules of the conflict set, add constraints specified in the rules of the conflict set to working memory of the rules engine, and apply the rules in the conflict set in agenda order to the working memory.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for rules processing with MIP constraints.

FIG. 2 is a schematic illustration of a rules data processing system configured for rules processing with MIP constraints;

FIG. 3 is a flow chart illustrating a process for rules processing with MIP constraints;

FIG. 4 is a flow chart illustrating a process for rules selection performed by the rules selection module of FIG. 2;

FIG. 5 is a flow chart illustrating a process for conflict resolution performed by the conflict resolution module of FIG. 2; and,

FIG. 6 is a flow chart illustrating a process for rules application performed by the rules application module of FIG. 2.

### DETAILED DESCRIPTION OF THE INVENTION

Embodiments of the invention provide for rules processing with MIP constraints. In accordance with an embodiment of the invention, a set of rules can be selected from amongst a data store of rules, for example according to a RETE algorithm, in order to produce a candidate set of applicable rules. For each rule in the candidate set, if a constraint is detected in a left hand portion of an enveloping rule, the constraint can be tested and in response to a failure of a constraint when tested, the enveloping rule can be removed from the candidate set of applicable rules. Thereafter, the remaining rules in the candidate set are treated as the conflict set, ranked to produce an agenda and provided for conflict resolution in the rules engine.

During conflict resolution in the rules engine, for each rule in the conflict set in an order specified by the agenda, if a constraint is detected in a right hand portion of an enveloping rule, the constraint can be tested and in response to a failure of a constraint when tested, the enveloping rule can be removed from the conflict set of applicable rules. Thereafter, the conflict set of rules can be applied first by calling an optimization engine to retract constraints specified by the right hand portion of the rules in the conflict set, and subsequently by processing within the optimization engine the constraints not retracted in the conflict set in an order specified by the agenda. For those determined by the optimization engine to be feasible, the constraints can be added to working memory of the rules engine. Finally, the conflict set of rules can be applied to the working memory by the rules engine in an order specified by the agenda.

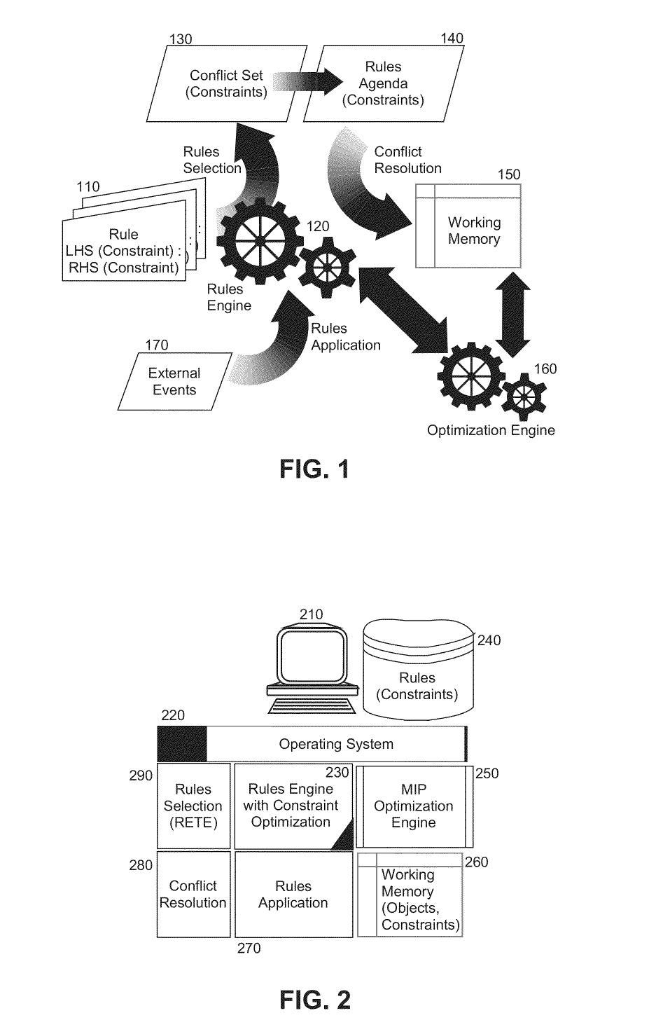

In further illustration, FIG. 1 pictorially shows a process for rules processing with MIP constraints. As shown in FIG. 1, a set of rules 110 configured for processing by a rules engine 120 in a BRMS can be configured to include not only business rules but also constraints processible in an optimization engine 160. In this regard, the rules can include a left hand side and a right hand side. The left hand side can express a condition upon which the content of the right hand side is to be added to working memory 150 by the rules engine 120. A candidate set of the rules 110 can be selected for processing by the rules engine 120, for example according to the RETE algorithm.

Thereafter, each rule in the candidate set of the rules 110 that includes a constraint can be evaluated so that rules in the candidate set that envelop failed constraints are removed leaving a conflict set 130 of the rules 110. Subsequently, the conflict set 130 can be resolved through the removal of rules containing non-viable constraints and an agenda 140 can be established for the conflict set 130. The rules of the agenda 140 in turn can be passed to the rules engine 120 for processing in accordance with one or more external events 170. Prior to processing, however, the constraints in each rule of the agenda 140 can be passed to the optimization engine 160 for addition to the working memory 150. Rules of the agenda 140 enveloping constraints not able to be added to the working memory 150 by the optimization engine are removed from the agenda 140 and the constraints therein retracted. Finally, the remaining rules of the agenda 140 are applied to the working memory 150 by the rules engine 120.

The process described in connection with FIG. 1 can be implemented in a rules data processing system. In yet further illustration, FIG. 2 is a schematic illustration of a rules data processing system configured for rules processing with MIP constraints. The system can include a host computer 210 with at least one processor and memory. An operating system 220 can execute in the memory of the host computer 210 and can support the operation of a rules engine 230 and an optimization engine 250 in connection with a data store of rules 240 and working memory 260. The rules engine 230 can include three different modules: a rules selection module 290, a conflict resolution module and a rules application module 270.

The rules selection module 290 can include program code enabled to select a candidate set of rules from the data store of rules 240 in accordance with a RETE algorithm. The program code of the rules selection module 290 further can be enabled to reduce the candidate set of rules by testing constraints found within different ones of the rules and removing rules in the candidate set that envelop constraints failing testing by the optimization engine 250. The resultant set of rules from the candidate set can be presented to the rules engine upon which conflict resolution can performed prior to the generation of an agenda therefrom.

The conflict resolution module 280 in turn can include program code enabled to perform conflict resolution upon the candidate set produced by the rules selection module 290. In this regard, the program code of the conflict resolution module 280 can be enabled to remove rules from the candidate set that envelope constraints to be added to the working memory 260 that are deemed infeasible by the optimization engine 250. Finally, the rules application module 270 can include program code enabled first to call the optimization engine 250 to add constraints enveloped in rules of the conflicts set and second to apply the rules of the conflicts set to objects and constraints in the working memory 260 in an order dictated by the generated agenda.

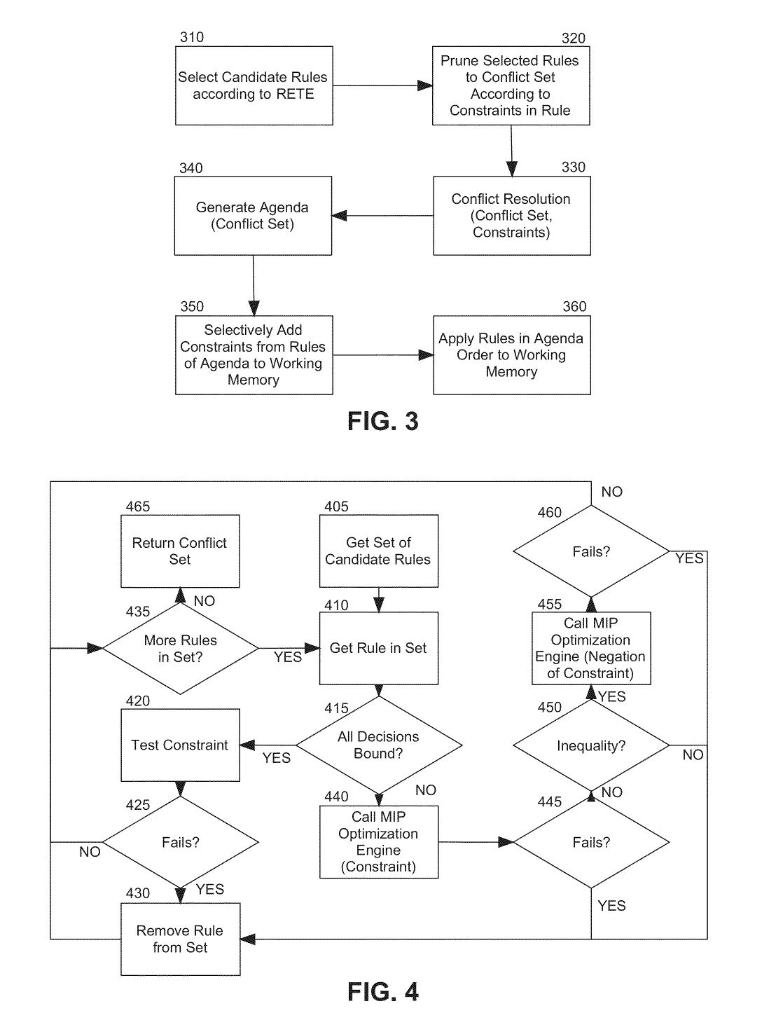

In even yet further illustration, FIG. 3 is a flow chart illustrating a process for rules processing with MIP constraints. Beginning in block 310, a selection of rules can be chosen according to a RETE algorithm. In block 320, the selection of rules can be reduced to a candidate set according to constraints enveloped by the rules. Thereafter, in block 330 the candidate set can be further reduced to a conflict set and in block 340, an agenda can be created for the conflict set. In block 350, constraints from the rules of the conflict set in an order specified by the agenda can be selectively added to working memory. Finally, in block 360 the rules can be applied in agenda order to the working memory.

In more particular illustration of the selection of the rules, FIG. 4 is a flow chart illustrating a process for rules selection performed by the rules selection module of FIG. 2. Beginning in block 405, a set of rules can be retrieved and in block 410 a first rule in the set can be selected for processing. In decision block 415, it can be determined whether or not all decisions implicated by the rule are bound by a left hand side constraint of the rule. If so, in block 420 the enveloped constraint can be tested and in decision block 425, if the constraint fails in block 430 the enveloping rule can be removed from the set of selected rules. Thereafter, in decision block 435 if more rules remain in the set of rules to be processed, in block 410 the process can repeat.

In decision block 415, if all decision of the selected rule are not bound, in block 440 the optimization engine can be called to test the constraint enveloped by the rule. In decision block 445 if the constraint fails testing, in block 430 the enveloping rule can be removed from the set of selected rules. Otherwise, in decision block 450 if the constraint is one of inequality the optimization engine can be called to test the negation of the constraint. Thereafter, in decision block 460 if the negation fails, in block 430 the enveloping rule can be removed from the set of rules. Thereafter, again it can be determined in decision block 435 whether or not additional rules remain to be processed in the set of selected rules. When no rules remain, in block 465 the remaining rules can be returned as a candidate set for processing into a conflict set of rules.

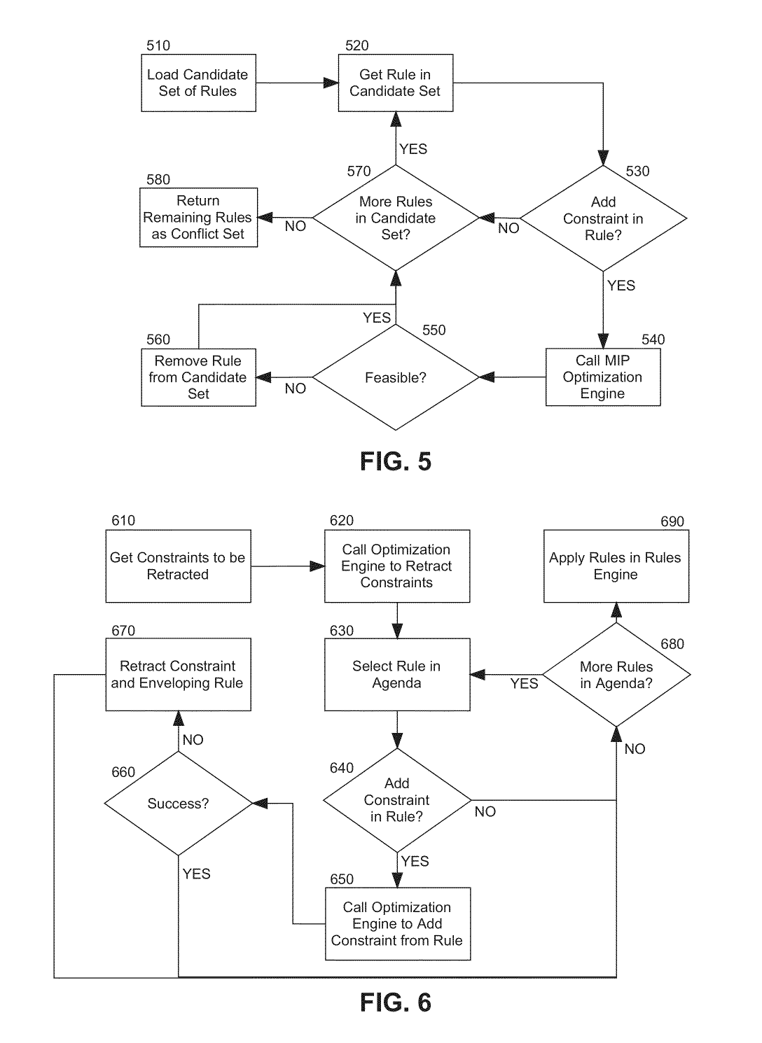

In more particular illustration of the resolution of the conflict set, FIG. 5 is a flow chart illustrating a process for conflict resolution performed by the conflict resolution module of FIG. 2. Beginning in block 510, the candidate set of rules can be loaded for processing and in block 520, a first rule in the candidate set can be selected for processing. In decision block 530, it can be determined if the rule envelops a right hand side constraint for addition to working memory. If so, in block 540 the optimization can be called to determine the feasibility of the constraint. If in decision block 550 the optimization engine determines the constraint to be infeasible, the enveloping rule can be removed from the candidate set in block 560. Thereafter, in decision block 570 if additional rules remain in the candidate set for processing the process can repeat in block 520. Otherwise, the rules remaining in the candidate set can be returned as the conflict set for conflict resolution by the rules engine.

Finally, in more particular illustration of the application of the rules remaining in the conflict set, FIG. 6 is a flow chart illustrating a process for rules application performed by the rules application module of FIG. 2. Beginning in block 610 a selection of constraints to be retracted can be retrieved and in block 620 the optimization engine can be called to retract the constraints in the selection. In block 630 a first rule specified by the agenda in the conflict set can be selected for processing and in decision block 640 it can be determined if the rule specifies in the right hand portion of the rule to add a constraint to working memory. If so, in block 650 the optimization engine can be called to add the constraint from the rule and in decision block 660, if the addition of the constraint fails, the rule can be removed from the conflict set and the enveloped constraint can be retracted in block 670. In either event, in decision block 680 if other rules in the conflict set remain to be processed, in block 630 a next rule specified by the agenda can be selected for processing. Otherwise, if no further rules remain to be processed, in block 690 the rules in the conflict set that remain can be applied to the working memory.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of rules processing with mixed integer programming (MIP) constraints comprising:
selecting into a candidate set individual candidate rules from amongst a plurality of rules in a rules engine executing in memory of a computer;
removing from the candidate set candidate rules according to constraints specified in the candidate rules;
conflict resolving the rules in the conflict set;
generating an agenda for the rules of the conflict set;
adding constraints specified in the rules of the conflict set to working memory of the rules engine; and,
applying the rules in the conflict set in agenda order to the working memory.

2. The method of claim 1, wherein the candidate rules are selected according to a Rete algorithm.

3. The method of claim 1, wherein the constraints specified in the candidate rules used to reduce the candidate rules are constraints specified in a left hand side of the candidate rules.

4. The method of claim 3, wherein the constraints specified in the rules that are added to the working memory are specified in a right hand side of the rules of the conflict set.

5. The method of claim 1, wherein the candidate rules are selected by selecting a set of rules and removing from the selected set of the rules only rules whose constraints fail testing so as to produce the candidate rules.

6. The method of claim 1, the candidate rules are reduced to the conflict set by including rules in the conflict set from the candidate rules that specify constraints determined by a MIP optimization engine to be feasible while excluding rules in the candidate set from the conflict set that specify constraints determined by a MIP optimization engine to be infeasible.
